(19) United States
(12) Patent Application Publication
(10) Pub. No.: US 2026/0147500 A1
(43) Pub. Date: May 28, 2026

(54) DATA PROCESSING

(71) Applicant: TENCENT TECHNOLOGY (SHENZHEN) COMPANY LIMITED, Shenzhen (CN)

(72) Inventors: Xiaolong HE, Shenzhen (CN); Anqun PAN, Shenzhen (CN); Hailin LEI, Shenzhen (CN); Chong ZHU, Shenzhen (CN)

(73) Assignee: TENCENT TECHNOLOGY (SHENZHEN) COMPANY LIMITED, Shenzhen, GD (CN)

(21) Appl. No.: 19/453,186

(22) Filed: Jan. 20, 2026

Related U.S. Application Data
(63) Continuation of application No. PCT/CN2024/119591, filed on Sep. 19, 2024.

(30) Foreign Application Priority Data
Oct. 7, 2023 (CN) 202311279539.0

(51) Int. Cl. G06F 3/06

(52) U.S. Cl. CPC G06F 3/0652; G06F 3/0604; G06F 3/0683

(57) ABSTRACT

In a data processing method, based on a write operation for target data in a log-structured merge tree, target expired data as a result of the write operation are determined. Based on a target keyword of the target expired data, the disk files included in each data layer are searched for one or more target disk files in which the target expired data is located. Target meta-information of the target expired data in the one or more target disk files and the target keyword are written into one or more respective cache structures. Based on a quantity of keywords in the cache structure corresponding to at least one data layer satisfying a preset quantity condition and based on meta-information identified by the keywords, expired data in the disk files are positioned. In the method, recovery processing is performed on the positioned expired data.

### RELATED APPLICATIONS

The present application is a continuation of International Application No. PCT/CN2024/119591, filed on Sep. 19, 2024, which claims priority to Chinese Patent Application No. 202311279539.0, entitled “DATA PROCESSING METHOD AND APPARATUS, ELECTRONIC DEVICE, AND STORAGE MEDIUM” and filed on Oct. 7, 2023. The entire disclosures of the prior applications are hereby incorporated by reference.

### FIELD OF THE TECHNOLOGY

This disclosure relates to the technical field of computers, including a data processing method and apparatus, an electronic device, and a storage medium.

### BACKGROUND OF THE DISCLOSURE

In a storage system based on a log-structured merge tree (LSM tree), expired data may need to be eliminated by means of compaction. The compaction refers to eliminating expired data from a storage engine according to certain policy to release a disk space.

In the related art, a record is regarded as expired data to be deleted only when encountering with a record with the same keyword (Key) and a greater version in the compaction process. However, an encountering occasion of two identical records in the compaction process is uncontrollable, one expired record may be still stored in a system after being compacted for multiple times (write amplification), so computing resource of the system and input/output (I/O) resource of a disk are wasted. Secondly, the expired data may be read to an internal memory from the disk and then discarded through a scanning query, so high read delay (read amplification) may be caused. Finally, if the expired data exists in a database system for a long time, the disk space cannot be effectively utilized (space amplification).

Therefore, an expired data recovery mode in the related art is a passive recovery mechanism, and the system resource cannot be effectively utilized.

### SUMMARY

This disclosure provides a data processing method and apparatus, an electronic device, and a storage medium.

In one aspect, this disclosure provides a data processing method. In the method, based on a write operation for target data in a log-structured merge tree, target expired data as a result of the write operation are determined. The log-structured merge tree includes at least two data layers, and each data layer includes a preset quantity of disk files. A keyword of the target data is determined as a target keyword of the target expired data. Based on the target keyword, the disk files included in each data layer are searched for one or more target disk files in which the target expired data is located. Target meta-information of the target expired data in the one or more target disk files and the target keyword identifying the target meta-information are written, by processing circuitry, into one or more respective cache structures corresponding to the at least two data layers in which the one or more target disk files are located. Based on a quantity of keywords in the cache structure corresponding to at least one data layer satisfying a preset quantity condition and based on meta-information identified by the keywords in the cache structure corresponding to the at least one data layer, expired data in the disk files included in the at least one data layer are positioned. In the method, recovery processing is performed by the processing circuitry on the positioned expired data.

In one aspect, this disclosure provides a data processing apparatus. The data processing apparatus includes processing circuitry configured to determine, based on a write operation for target data in a log-structured merge tree, target expired data as a result of the write operation. The log-structured merge tree includes at least two data layers, and each data layer includes a preset quantity of disk files. The processing circuitry is configured to determine a keyword of the target data as a target keyword of the target expired data. The processing circuitry is configured to search, based on the target keyword, the disk files included in each data layer for one or more target disk files in which the target expired data is located. The processing circuitry is configured to write target meta-information of the target expired data in the one or more target disk files and the target keyword identifying the target meta-information into one or more respective cache structures corresponding to the at least two data layers in which the one or more target disk files are located. The processing circuitry is configured to position, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer. The processing circuitry is configured to perform recovery processing on the positioned expired data.

In one aspect, this disclosure provides a non-transitory computer-readable storage medium storing instructions. The instructions, which when executed by a processor, cause the processor to determine, based on a write operation for target data in a log-structured merge tree, target expired data as a result of the write operation. The log-structured merge tree includes at least two data layers, and each data layer includes a preset quantity of disk files. The instructions, which when executed by the processor, cause the processor to determine a keyword of the target data as a target keyword of the target expired data. The instructions, which when executed by the processor, cause the processor to search, based on the target keyword, the disk files included in each data layer for one or more target disk files in which the target expired data is located. The instructions, which when executed by the processor, cause the processor to write target meta-information of the target expired data in the one or more target disk files and the target keyword identifying the target meta-information into one or more respective cache structures corresponding to the at least two data layers in which the one or more target disk files are located. The instructions, which when executed by the processor, cause the processor to position, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer. The instructions, which when executed by the processor, cause the processor to perform recovery processing on the positioned expired data.

In one aspect, this disclosure provides a data processing method. The method includes: determining, in response to a write operation for target data in a log-structured merge tree, expired data generated by the write operation; the log-structured merge tree including at least two data layers, each data layer including a preset quantity of disk files, each data layer corresponding to a cache structure, and each cache structure being configured to store meta-information of the expired data in the corresponding data layer; determining a keyword of the target data as a target keyword of the expired data; searching, based on the target keyword, the preset quantity of disk files included in each data layer for a target disk file in which the expired data is located; writing the target keyword into the cache structure corresponding to the data layer in which the target disk file is located; the target keyword being configured for identifying the meta-information of the expired data in the target disk file; and positioning, in response to the quantity of the keyword in the cache structure corresponding to at least one data layer satisfying a preset quantity condition and by means of the meta-information identified by the keyword in the cache structure respectively corresponding to the at least one data layer, the expired data in the disk files included in the at least one data layer, and performing recovery processing on the positioned expired data.

In another aspect, this disclosure provides a data processing apparatus. The apparatus includes: an expired data acquiring module, configured to determine, in response to a write operation for target data in a log-structured merge tree, expired data generated by the write operation; the log-structured merge tree including at least two data layers, each data layer including a preset quantity of disk files, each data layer corresponding to a cache structure, and each cache structure being configured to store meta-information of the expired data in the corresponding data layer; a target disk file searching module, configured to determine a keyword of the target data as a target keyword of the expired data, and search, based on the target keyword, the preset quantity of disk files included in each data layer for a target disk file in which the expired data is located; a keyword writing module, configured to write the target keyword into the cache structure corresponding to the data layer in which the target disk file is located; the target keyword being configured for identifying the meta-information of the expired data in the target disk file; and a recovery module, configured to position, in response to the quantity of the keyword in the cache structure corresponding to at least one data layer satisfying a preset quantity condition and by means of the meta-information identified by the keyword in the cache structure respectively corresponding to the at least one data layer, the expired data in the disk files included in the at least one data layer, and perform recovery processing on the positioned expired data.

In another aspect, this disclosure provides an electronic device for data processing. The electronic device includes processing circuitry (for example, a processor) and a memory. The memory has at least one instruction or at least one program stored therein, and the at least one instruction or the at least one program is loaded and executed by the processor to implement the data processing method as mentioned above.

In another aspect, this disclosure provides a non-transitory computer-readable storage medium. The non-transitory computer-readable storage medium has at least one instruction or at least one program stored therein, and the at least one instruction or the at least one program is loaded and executed by a processor to implement the data processing method as mentioned above.

In another aspect, this disclosure provides a computer program product, which includes a computer program, and the computer program, when executed by a processor, implements the data processing method as mentioned above.

Details of one or more embodiments of this disclosure are provided in the accompanying drawings and descriptions below.

### BRIEF DESCRIPTION OF THE DRAWINGS

To illustrate technical solutions in embodiments of this disclosure, the accompanying drawings will be briefly introduced below. The accompanying drawings in the following description are only some embodiments of this disclosure. Other embodiments are within the scope of the present disclosure.

FIG. 1 is a schematic diagram of an implementation environment of a data processing method according to an embodiment.

FIG. 2 is a schematic flow chart of a data processing method according to an embodiment.

FIG. 3 is a schematic diagram of a cache structure according to an embodiment.

FIG. 4 is a schematic flow chart of an operation of searching, based on a target keyword, a preset quantity of disk files included in each data layer for a target disk file in which expired data is located according to an embodiment.

FIG. 5 is a schematic flow chart of an operation of searching, based on a target keyword, a preset quantity of disk files included in each data layer for a target disk file in which expired data is located according to another embodiment.

FIG. 6 is a schematic flow chart of a data processing method according to an embodiment.

FIG. 7 is an overall framework diagram of a TDSQL distributed database system according to an embodiment.

FIG. 8 is a storage framework diagram of a single storage node according to an embodiment.

FIG. 9 is a block diagram of a data processing apparatus according to an embodiment.

FIG. 10 is a block diagram of a hardware structure of a server provided according to an embodiment.

### DESCRIPTION OF EMBODIMENTS

The technical solutions in embodiments of this disclosure will be described hereinafter with reference to the accompanying drawings in the embodiments of this disclosure. The described embodiments are only some rather than all of the embodiments of this disclosure. Other embodiments are within the scope of this disclosure.

To better describe this disclosure, technical terms used in this disclosure are first explained below. The descriptions of the terms are provided as examples only and are not intended to limit the scope of the disclosure.

LSM tree: an LSM tree may correspond to a data structure, supporting operations of adding, deleting, reading, modifying, and sequential scanning, and avoiding a problem of random write to a disk by using a batch storage technology. A feature of the LSM tree is to improve write performance by using sequential write. However, a layered design (the layered herein refers to division into two parts including internal memory and file) may slightly reduce read performance. In some examples, by sacrificing a small part of read performance to achieve high-performance write, the LSM tree has become a very popular storage structure. Databases implemented based on the LSM tree may include, but are not limited to, LevelDB, HMase, and the like. The LevelDB is an efficient kv database (for example, for key-value storage). The HBase is a distributed column-oriented open-source database.

A structure of the LSM tree may be described below as a non-limiting example.

The LSM tree may include the following three parts:
MemTable (Internal memory table): an internal memory table may correspond to a data structure in an internal memory, which may be configured to store recently updated data, and may orderly organize the data according to keywords Keys. In some examples, the LSM tree is not based on any data structure definition on a specific mode of organizing and orderly organizing data. For example, the Hbase may use a skip list to handle the order of Keys in the internal memory.

Because the data is temporarily stored in the internal memory, the internal memory is not reliable storage, and may lose the data when power is cut off, the data reliability may be in a Write-ahead logging (WAL) mode.
Immutable MemTable (Immutable internal memory table): after reaching a particular size, an internal memory table may be converted into an immutable internal memory table. The immutable internal memory table may correspond to an intermediate state of converting the internal memory table into an ordered key-value pair set. A write operation is processed by a new internal memory table, and a data update operation is not blocked in a transfer process.
SSTable (Sorted String Table): an SSTable may correspond to an ordered key-value pair set, and may correspond to a data structure of an LSM tree group in a disk. To accelerate the reading of the ordered key-value pair set, searching for a Key may be accelerated by establishing an index of the Key and through a bloom filter.
Compaction: in a storage engine implemented based on an LSM tree, the storage engine may periodically perform a data merging operation, dirty data may be eliminated in this process, and this action of eliminating dirty data may be referred to as a compaction action.

The LSM tree may store records of all operations such as data insertion, modification, and deletion into an internal memory. Such operations are sequentially written into a disk in batches after reaching certain data quantity. When the internal memory table reaches certain size, and after the data is flushed to a persistent storage state to become an ordered key-value pair set, there may be records of the same Key in different ordered key-value pair sets, and the latest record is accurate. The Flush operation is to forcibly write data in a cache into a main memory or a disk to further the consistency and reliability of the data.

In some data index structures, meta-information may be stored by using a layered mechanism. The meta-information is data describing actual data, and is configured for describing attribute (feature) information of the actual data. For example, the meta-information may be a file name of the actual data, or a storage address pointer of the actual data, or the like. Meanwhile, the meta-information may further have a corresponding identifier to identify the meta-information. The meta-information and the corresponding identifier thereof may form a key-value pair. Each key-value pair may include a keyword (Key) and a value (Value) corresponding to the Key. The Value is the meta-information per se, and the Key is configured for identifying the Value of the meta-information.

The LSM tree may be divided into N+1 layers (N is a positive integer), which are respectively an L0 layer, an L1 layer, . . . , and an LN layer. In some examples, L0 layer may be referred to as a top data layer, L1 layer may be referred to as a second-to-top data layer, and LN layer may be referred to as a bottom data layer. Data in the L0 layer may be stored in an internal memory of a storage device. Because an internal memory space may be small, a data scale of the L0 layer may be small. Meta-information in the L1 layer to the LN layer of the LSM tree may be stored in a storage device such as a disk, and in addition, a storage space of the disk may be large. Therefore, the L1 layer to the LN layer may have a large data scale. Each of the L0 layer to the LN layer may have one or more subtrees of the LSM tree.

When new data is written into the LSM tree, new meta-information and a corresponding keyword thereof may be written into the subtree of the L0 layer in a form of a key-value pair (Key-Value). When a data quantity in the L0 layer exceeds certain threshold, data in the L0 layer may be merged, and data obtained after the merging is written into the subtree in the L1 layer. Therefore, the internal memory may have more spare internal memory space to store other newly written data. Similarly, when a data scale in the L1 layer exceeds a preset threshold, data in the L1 layer may be merged, data obtained after the merging is written into the subtree in the L2 layer, and so on. In continuous merging and writing processes, a data scale of a next-layer subtree may become larger.

In a process of merging data in each layer, Values corresponding to the same Key may be merged into a new Value, a new key-value pair is constructed based on a new Value and the original Key, the Key of the new key-value pair is unchanged, and the Value of the new key-value pair is the new Value obtained after merging. Therefore, redundant invalid information in the LSM tree may be eliminated to achieve a goal of reducing storage overheads.

Read amplification: read amplification may correspond to a scenario that, during data reading, an actually read data quantity is greater than a real data quantity. For example, in an LSM tree, whether a current Key exists or not may be first checked in an internal memory table, and if the current Key does not exist in the internal memory table, continuously searching from the ordered key-value pair set.

Write amplification: write amplification may correspond to a scenario that, during data writing, an actually written data quantity is greater than a real data quantity. For example, a Compact operation may be triggered during writing in an LSM tree, so the actually written data quantity may be much greater than the data quantity of the Key.

Space amplification: space amplification may correspond to a scenario that data actually occupies more disk space than a real size of the data. For a Key, only the latest record is valid, and previous records may be cleared and recovered.

Terms “first”, “second”, and the like used in the description of the embodiments of this disclosure, the claims, and the accompanying drawings are intended to distinguish similar objects but do not necessarily indicate a specific order or sequence. Data used in such a way may be interchanged in proper circumstances, so that the embodiments of this disclosure described herein may be implemented in other orders than the order illustrated with reference to the drawings or described herein. Terms “include” and “have” and any of their variations are intended to cover non-exclusive inclusion. For example, a process, method, system, product, or server that includes a series of operations or units is not limited to the listed operations or units; and instead, it may further include other operations or units that are not listed or intrinsic to the process, method, product, or device.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

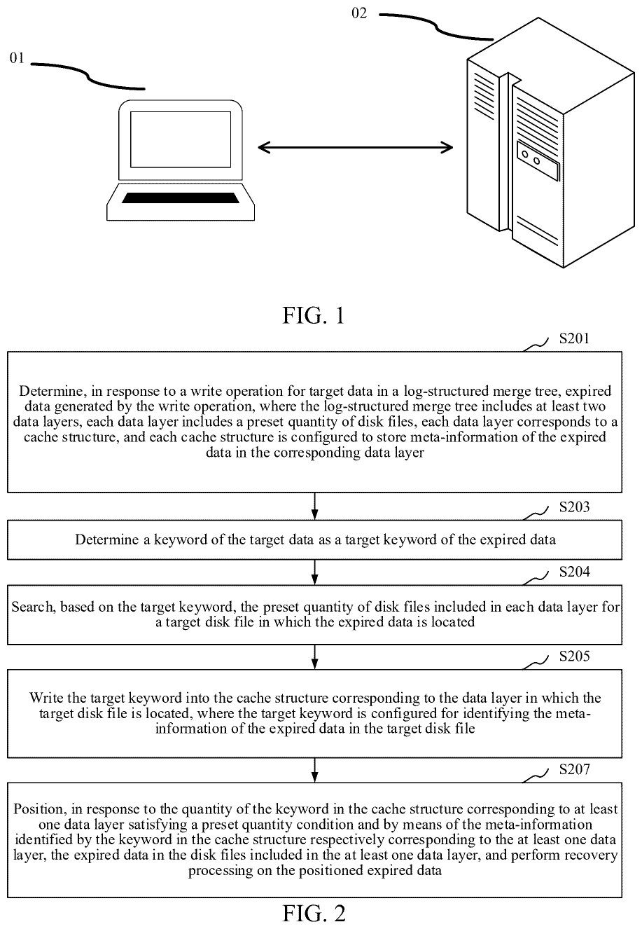

FIG. 1 is a schematic diagram of an implementation environment of a data processing method according to an embodiment. As shown in FIG. 1, the implementation environment may at least include a terminal 01 and a server 02. The terminal 01 and the server 02 may be directly or indirectly connected in a wired or wireless communication mode, which is not limited in embodiments of this disclosure.

Specifically, the server 02 may be configured to fast position and recognize expired data, and recover the expired data. In an embodiment, the server 02 may be an independent physical server, or may also be a server cluster or a distributed system formed by a plurality of physical servers, or may be a cloud server that provides basic cloud computing services such as cloud service, a cloud database, cloud computing, a cloud function, cloud storage, network service, cloud communication, middleware service, domain name service, security service, a content delivery network (CDN), as well as a big data and artificial intelligence platform.

Specifically, the terminal 01 may be configured to acquire expired data generated by a write operation, and transmit the expired data to the server 02. The terminal 01 may be a smartphone, a tablet computer, a notebook computer, a desktop computer, a smart speaker, a smartwatch, a smart voice interaction device, a smart household appliance, an on-board terminal, aerocraft, and the like, but is not limited thereto. The terminal and the server may be directly or indirectly connected in a wired or wireless communication mode, which is not limited in this disclosure.

Embodiments of the present disclosure may be applied to various scenes, including but not limited to a cloud technology, artificial intelligence, intelligent transportation, assisted driving, and the like.

FIG. 1 is only an example. In another scenes, other implementation environments may further be included.

FIG. 2 is a schematic flow chart of a data processing method according to an embodiment. The method may be used in the implementation environment in FIG. 1. This specification provides operations of the method according to the embodiments or the flow chart, but more or fewer operations may be included. The sequence of operations listed in embodiments is merely one mode of various operation implementation sequences, and does not represent the unique implementation sequence. During practical system or server product execution, the operations may be performed according to a method sequence shown in the embodiments or the accompanying drawings or may be performed in parallel (for example, a parallel processor or multi-threaded processing environment). As shown in FIG. 2, the method may include:
S201: Determine, in response to a write operation for target data in a log-structured merge tree, expired data generated by the write operation, where the log-structured merge tree includes at least two data layers, each data layer includes a preset quantity of disk files, each data layer corresponds to a cache structure, and each cache structure is configured to store meta-information of the expired data in the corresponding data layer. For example, target expired data may be determined based on a write operation for target data in a log-structured merge tree as a result of the write operation. The log-structured merge tree includes at least two data layers, and each data layer includes a preset quantity of disk files.

In an embodiment, the target data is data which has been already stored in an LSM tree, and the data is a target of the write operation. The LSM tree includes at least two data layers, and each data layer includes a preset quantity of disk files. A data structure of the LSM tree in a disk is an ordered key-value pair set, that is, the disk file stores meta-information of data and a keyword corresponding to the meta-information. The meta-information and the corresponding keyword thereof are written into the LSM tree in a form of a key-value pair (Key-Value).

In an embodiment, the write operation is a write operation capable of generating expired data (for example, causing previously-stored data to become obsolete or expired as a result of the write operation). Since the write operation capable of generating expired data may finally generate additional expired data after falling onto a data layer, to fast and accurately position the disk file in which the expired data is located, which write loads falling into a database system may generate expired data may be determined according to a front end operation. Further, in the database system, except that an Insert write operation may not generate expired data, expired data may be generated after other write operations are successfully written. Therefore, the write operation capable of generating expired data may be a write operation other than the Insert write operation, and for example, may be an operation such as updating or deletion of an application load.

In some examples, the expired data may include, but is not limited to, invalid data, data of a low version, dirty data, and the like. The dirty data refers to data that is not in a given range or has no significance for an actual service, or data in an illegal format, or data that is not normally coded, or data that has an unclear service logic.

Besides two parts of structures of an internal memory and a disk file in the related art, the LSM tree in embodiments of this disclosure additionally maintains a cache structure (an internal memory cache Buffer) for each data layer. Each cache structure is configured to store meta-information of expired data in the corresponding data layer. The order of Keys is maintained by using a simple skip list inside each internal memory cache Buffer.

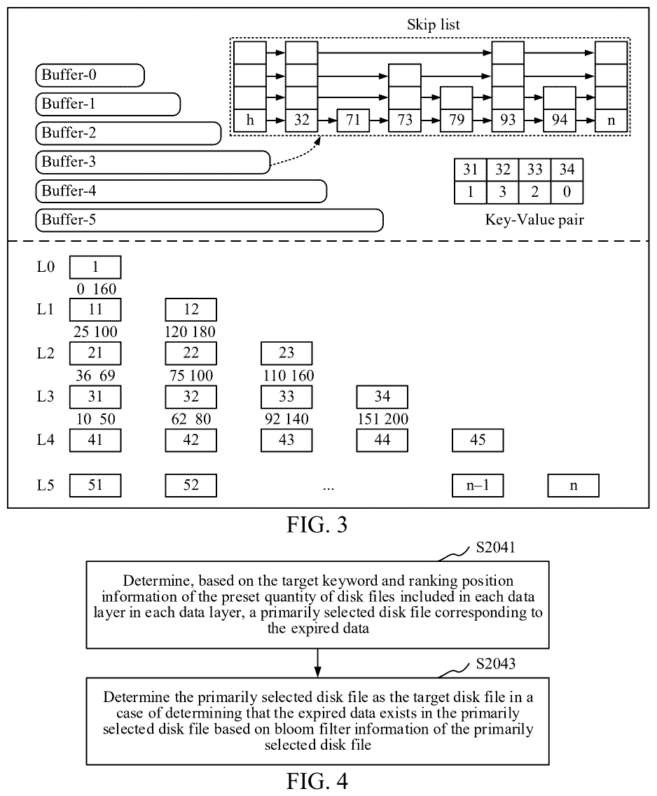

FIG. 3 is a schematic diagram of a cache structure according to an embodiment. As shown in FIG. 3, it is supposed that the LSM tree includes 6 data layers (L0, L1, L2, L3, L4, and L5), one internal memory cache Buffer0 may be maintained for L0, one internal memory cache Buffer1 may be maintained for L1, one internal memory cache Buffer2 may be maintained for L2, one internal memory cache Buffer3 may be maintained for L3, one internal memory cache Buffer4 may be maintained for L4, and one internal memory cache Buffer5 may be maintained for L5. A number in each data layer refers to a file identifier (SSTable ID) of a disk file, for example, “34” in the L3 layer. A number below the file identifier refers to a range of a maximum Key and a minimum Key corresponding to the disk file. For example, “151” below “34” in the L3 layer refers to the minimum Key, and “200” refers to “the maximum Key”. In embodiments of this disclosure, the meta-information of expired data is stored by using the cache structure, and the meta-information of the expired data is identified by using a corresponding Key.

In this embodiment, data written into the LSM tree exists in a form of a key-value pair formed by the meta-information of the data and the Key corresponding to the meta-information, a piece of expired data may be generated when a terminal object performs a write operation on the meta-information of the target data stored in the LSM tree, and the terminal may transmit the expired data to the server, or the server may directly acquire the expired data from the terminal.

One terminal object may perform a write operation on different data in the LSM at the same time to generate a plurality of pieces of expired data; and different terminal objects may also perform a write operation on different data or the same data in the LSM tree at the same time to generate a plurality of pieces of expired data, which is not specifically limited in this disclosure.
S203: Determine a keyword of the target data as a target keyword of the expired data (for example, the target expired data).
S204: Search, based on the target keyword, the preset quantity of disk files included in each data layer for a target disk file in which the expired data is located. For example, the disk files included in each data layer are searched for one or more target disk files in which the target expired data is located based on the target keyword.

The LSM tree per se stores the key-value pair formed by the meta-information of the data and the Key corresponding to the meta-information, each key-value pair may include a keyword (Key) and a value (Value) corresponding to the Key. The Value is the meta-information per se, and the Key is configured for identifying the meta-information serving as the Value. However, in a write operation process for the target data, the corresponding Key does not change. Therefore, the server may directly use the keyword of the target data stored in the LSM tree as the target keyword of the expired data. In addition, through the target keyword, the preset quantity of disk files included in each data layer are actively, precisely, and fast searched for the target disk file in which the expired data is located. That is, the expired data being located in which target disk file of which data layer in the LSM tree is actively, precisely, and rapidly identified.
S205: Write the target keyword into the cache structure corresponding to the data layer in which the target disk file is located, where the target keyword is configured for identifying the meta-information of the expired data in the target disk file. For example, target meta-information of the target expired data in the one or more target disk files and the target keyword identifying the target meta-information are written, by processing circuitry, into one or more respective cache structures corresponding to the at least two data layers in which the one or more target disk files are located.

In this embodiment, after the server positions the target disk file in which the expired data is located, the corresponding cache structure is maintained for each disk file. The server may directly write the target keyword of the expired data into the cache structure corresponding to the data layer in which the target disk file is located, so that the meta-information of the expired data in the target disk file may be identified through the target keyword.
S207: Position, in response to the quantity of the keyword in the cache structure corresponding to at least one data layer satisfying a preset quantity condition and by means of the meta-information identified by the keyword in the cache structure respectively corresponding to the at least one data layer, the expired data in the disk files included in the at least one data layer, and perform recovery processing on the positioned expired data. For example, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer are positioned. Recovery processing is performed by the processing circuitry on the positioned expired data.

In this embodiment, when the server positions the expired data by using the cache structure designed for the expired data and an algorithm for fast positioning the expired data, the server may actively identify the quantity of the expired data in each disk file, and may diversely trigger a program for recovering the expired data according to the information.

The preset quantity condition may be a magnitude relationship between the quantity of keywords and the threshold. The threshold may be preset according to requirements, or may further be dynamically set according to a historical recovery processing record. The preset quantity condition may be that a relative relationship between the quantity of keywords and another quantity conforms to a preset relationship. For example, another quantity may be a preset quantity, or a total quantity of keywords in the cache structure corresponding to at least one data layer. The relative relationship may be, for example, a ratio or another functional relationship. The recovery processing may be processing for releasing a storage space occupied by expired data. Further, the recovery processing may be a process for deleting expired data and recovering a storage space occupied by the deleted expired data.

According to the embodiments of this disclosure, through the cache structure designed for the expired data and the algorithm for fast positioning the expired data, the conversion of passive recognition of the expired data into active recognition may be realized, so that the specific disk file in which the expired data falls may be fast positioned. The corresponding keyword is written into the corresponding cache structure, then the quantity of the expired data in each disk file may be precisely estimated through the quantity of the keywords stored in the cache structure, and the expired data in each disk file may be further precisely and timely recovered according to the quantity of the expired data in each disk file, so that the storage efficiency, the system performance, and the query efficiency of the distributed database are improved, and space and resource waste is reduced. This disclosure may have the following specific beneficial effects:
A storage space may be released in time: by actively recognizing and recovering the expired data, the storage space may be released in time, and the occupation of excessive storage resources by the data is avoided. The storage efficiency is favorably improved, and space waste is reduced.
System performance is improved: by actively recognizing and recovering the expired data, unnecessary data access and processing operations may be reduced, so that the system read and write performance may be improved. The existence of the expired data is reduced, so that the data access complexity and redundancy may be reduced.
The query efficiency is optimized: by actively recognizing the expired data, the data quantity to be processed in a query operation may be reduced, so that the query efficiency may be improved. By eliminating the expired data, required valid data may be positioned and retrieved faster.
Data consistency and reliability are improved: by actively recognizing the expired data, the impact of the expired data on a system may be reduced, and the data consistency and reliability may be improved. By clearing the expired data in time, the negative impact of the expired data on the system functions and performance may be avoided.

The process of searching, based on the target keyword, the preset quantity of disk files included in each data layer for a target disk file in which the expired data is located in operation S204 may be implemented in various modes, which is not specifically limited therein.

In an implementation, the preset quantity of disk files included in each data layer may be read to search the target disk file in which the expired data is located. In another implementation, the target disk file in which the expired data is located may be determined in a mode of combining binary search with a bloom filter.

The mode of combining binary search with the bloom filter may also be implemented in various modes. In one mode, binary search and a bloom filter operation may be sequentially performed according to the sequence of each data layer in the LSM tree. In another mode, the binary search and the bloom filter operation may be performed on each data layer in the LSM tree in parallel, or the binary search and the bloom filter operation may be performed on each data layer in the LSM tree in a random sequence as a non-limiting example.

Hereafter, the operation S204 is illustrated by taking the situation that the binary search and the bloom filter operation are performed on each data layer in the LSM tree in parallel or the binary search and the bloom filter operation are performed on each data layer in the LSM tree in a random sequence as a non-limiting example. FIG. 4 is a schematic flow chart of the operation of searching, based on the target keyword, the preset quantity of disk files included in each data layer for the target disk file in which the expired data is located. The operation may include:
S2041: Determine, based on the target keyword and ranking position information of the preset quantity of disk files included in each data layer in each data layer, a primarily selected disk file corresponding to the expired data. For example, based on the target keyword and ranking position information of the disk files included in each data layer, one or more primarily selected disk files corresponding to the target expired data are determined.

S2043: Determine the primarily selected disk file as the target disk file in a case of determining that the expired data exists in the primarily selected disk file based on bloom filter information of the primarily selected disk file. For example, the one or more primarily selected disk files are determined as the one or more target disk files based on a determination result that the target expired data exists in the one or more primarily selected disk files according to bloom filter information of the one or more primarily selected disk files.

In this embodiment, based on the target keyword and the ranking position information of the preset quantity of disk files included in each data layer in each data layer, the primarily selected disk file corresponding to the expired data may be determined in a mode of binary search, that is, a range of the disk file in which the expired data may be located may be determined. The bloom filter information of the primarily selected disk file is acquired from the internal memory. Whether the expired data exists in the primarily selected disk file or not is determined through the bloom filter information. If YES, the server determines that the primarily selected disk file is the target disk file. If NO, the server determines that the primarily selected disk file is not the target disk file.

The corresponding bloom filter information may be generated for each disk file in the LSM tree in advance. A process for generating the bloom filter information may include:
The bloom filter is a data structure formed by a bit array having a length of a preset bit and a preset quantity of independent hash functions. The bit array is initialized to be 0, and all the hash functions may respectively hash inputted data as uniform as possible. When the Key corresponding to the data in each disk file needs to be inserted into the bloom filter, the Key is calculated by the preset quantity of hash functions to generate a preset quantity of hash values. The Key is mapped to the position of the bit array through the preset quantity of hash values, an element in the mapped position of the bit array becomes 1, and one element may be mapped to a preset quantity of positions.

Therefore, the range of the disk file in which the expired data may be located may be first determined in a mode of binary search, and the binary search has the advantages of less comparison times, high search speed, and good average performance, so the range of the disk file in which the expired data may be located may be fast and precisely determined in a case of consuming less resources, and the primarily selected disk file in which the expired data may be located may be fast and precisely determined. On this basis, whether the expired data actually exists in the primarily selected disk file or not is determined through the bloom filter information of the primarily selected disk file. Whether certain Key exists in certain disk file or not is determined by using bloom filter information through the bit array and a plurality of hash functions, the space utilization rate is high, only the query on the bit array is needed while the actual data query is not needed, the query efficiency is high, the determination efficiency and determination precision of the target disk file may be improved, and the consumption of the determination process of the target disk file on the system resource is reduced.

In an embodiment, the preset quantity of disk files in each candidate data layer of the at least two data layers are sequentially arranged, and the operation of determining, based on the target keyword and ranking position information of the preset quantity of disk files included in each data layer in each data layer, a primarily selected disk file corresponding to the expired data may include:
compare the target keyword with a first candidate keyword of a disk file in a middle position in each candidate data layer.

In a case that the target keyword equals to the first candidate keyword, the primarily selected disk file is determined as the disk file in the middle position in each candidate data layer.

In a case that the target keyword is smaller than the first candidate keyword, disk files in front of the disk file in the middle position are searched for a disk file with the keyword being identical to the target keyword to acquire the primarily selected disk file. For example, based on the target keyword being smaller than the first candidate keyword, one or more other disk files in front of the first disk file in the middle position are searched. for a second disk file with a second candidate keyword being identical to the target keyword, the second disk file being determined as the one of the one or more primarily selected disk files.

In a case that the target keyword is greater than the first candidate keyword, disk files behind the disk file in the middle position are searched for a disk file with the keyword being identical to the target keyword to acquire the primarily selected disk file. For example, based on the target keyword being greater than the first candidate keyword, one or more disk files behind the disk file in the middle position are searched for a third disk file with a third candidate keyword being identical to the target keyword, the third disk file being determined as one of the one or more primarily selected disk files.

In this embodiment, the preset quantity of disk files in each candidate data layer are sequentially arranged, and the candidate data layer is a data layer other than the first data layer of the at least two data layers. For the binary search, the server may compare the target keyword with the first candidate keyword of the disk file in the middle position in each candidate data layer to determine whether the target keyword equals to the first candidate keyword or not. If YES, the server determines that the disk file is the disk file in the middle position in each candidate data layer. If NO, and in a case that the target keyword is smaller than the first candidate keyword, the disk files in front of the disk file in the middle position are searched for the disk file with the keyword being identical to the target keyword to acquire the primarily selected disk file. If NO, and in a case that the target keyword is greater than the first candidate keyword, the disk files behind the disk file in the middle position are searched for the disk file with the keyword being identical to the target keyword to acquire the primarily selected disk file.

In other implementations, if the disk file in which the expired data may fall is not found in the disk files in the candidate data layer in the above mode, the expired data may be considered to fall in the first data layer.

In another implementations, “the target keyword equals to the first candidate keyword” may also be replaced with “a difference between the target keyword and the first candidate keyword is smaller than a preset difference threshold”.

Therefore, the range of the disk file in which the expired data may be located may be fast and precisely positioned by using the first candidate keyword of the disk file in the middle position in each data layer as a boundary for binary search in a cases of few comparison times and low resource consumption. That is, the primarily selected disk file in which the expired data may be located may be fast and precisely determined.

In an embodiment, in operation S2043, the determining the primarily selected disk file as the target disk file in a case of determining that the expired data exists in the primarily selected disk file based on bloom filter information of the primarily selected disk file may include:
perform hashing processing on the target keyword through the preset quantity of hash functions to acquire a preset quantity (for example, a preset number) of hash values.

The target keyword is mapped to the bit array through the preset quantity of hash values to acquire a preset quantity of mapping results.

In a case that the preset quantity of mapping results are all 1, it is determined that the expired data exists in the primarily selected disk file, and the primarily selected disk file is determined as the target disk file.

In this embodiment, the corresponding bloom filter information is generated for each disk file in the LSM tree in advance. The bloom filter information is a data structure formed by a bit array having a length of a preset bit and a preset quantity of independent hash functions. The bit array is initialized to be 0, and the element in the mapped position of the bit array becomes 1.

On this basis, the server may perform hashing processing on the target keyword through the preset quantity of hash functions to acquire the preset quantity of hash values. The server maps the preset quantity of hash values to the bit array to acquire the preset quantity of mapping results. If one of the preset quantity of mapping results is 0, that is, one is not 1, it indicates that the target keyword is definitely not in the primarily selected disk file, and the primarily selected disk file is determined not to be the target disk file. If the preset quantity of mapping results are all 1, it indicates that the target keyword may exist in the primarily selected disk file, and the primarily selected disk file is determined as the target disk file.

Whether certain Key is in certain dish file or not is determined by using the bloom filter information through the bit array and the plurality of hash functions. If one of the preset quantity of mapping results is 0, it indicates that the target keyword is definitely not in the primarily selected disk file. If the preset quantity of mapping results are all 1, it indicates that the target keyword may exist in the primarily selected disk file, and the primarily selected disk file is determined as the target disk file. Therefore, the resource consumption of reading the disk file in the data layer to search the target disk file in which the target keyword is located may be avoided, the determination efficiency and determination precision of the target disk file are further improved, and the consumption of the target disk file determination process on the system resource is reduced.

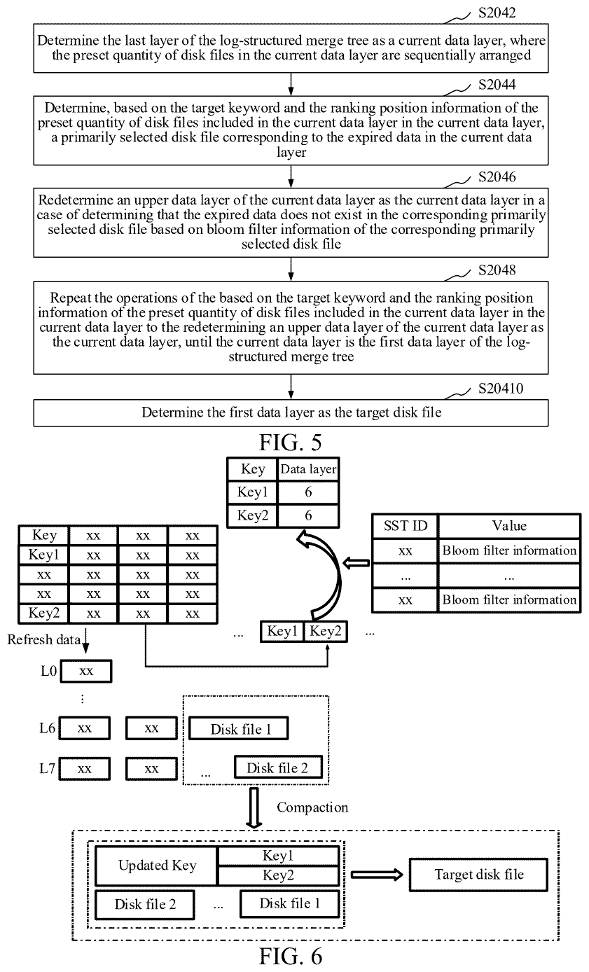

Operation S204 will be illustrated by taking the situation that the binary search and the bloom filter operation are sequentially performed according to the sequence of each data layer in the LSM tree as an example hereafter. FIG. 5 is a schematic flow chart of the operation of searching, based on the target keyword, the preset quantity of disk files included in each data layer for the target disk file in which the expired data is located. The operation may include:
S2042: Determine the last layer of the log-structured merge tree as a current data layer, where the preset quantity of disk files in the current data layer are sequentially arranged.
S2044: Determine, based on the target keyword and the ranking position information of the preset quantity of disk files included in the current data layer in the current data layer, a primarily selected disk file corresponding to the expired data in the current data layer.
S2046: Redetermine an upper data layer of the current data layer as the current data layer in a case of determining that the expired data does not exist in the corresponding primarily selected disk file based on bloom filter information of the corresponding primarily selected disk file.
S2048: Repeat the operations of the based on the target keyword and the ranking position information of the preset quantity of disk files included in the current data layer in the current data layer to the redetermining an upper data layer of the current data layer as the current data layer, until the current data layer is the first data layer of the log-structured merge tree.
S20410: Determine the first data layer as the target disk file.

In some examples, operation S204 corresponds to, for each current data layer from a bottom data layer (for example, LN layer) to a second-to-top data layer (for example, L1 layer) of the log-structured merge tree, and based on the target keyword and ranking position information of the disk files included in the current data layer, a current one of the one or more primarily selected disk files corresponding to the target expired data in the current data layer is determined. In some examples, operation S204 corresponds to the disk file in a top data layer of the log-structured merge tree is determined as one of the one or more target disk files.

Correspondingly, the method may further include:
determine the corresponding primarily selected disk file as the target disk file in a case of determining that the expired data exists in the corresponding primarily selected disk file based on bloom filter information of the corresponding primarily selected disk file. For example, for each current data layer from the bottom data layer to the second-to-top data layer of the log-structured merge tree, the current one of the one or more primarily selected disk files are determined as one of the one or more target disk files based on a determination result that the target expired data exists in the corresponding primarily selected disk file based on the bloom filter information of the corresponding primarily selected disk file.

In this embodiment, there is an intersection among the files in the L0 layer (first layer) of the LSM tree, and the disk files in L1 to the last layer are sequenced in order. If traversal is performed from the last data layer, and if the target disk file in which the expired data is located may be found, the data layers in front of the last data layer do not need to be traversed, so that the traversal times may be reduced, and the consumption of the target disk file determination process on the system resource may be reduced. Therefore, the server may first transverse the last data layer, and the last data layer is used as the current data layer. The primarily selected disk file corresponding to the expired data in the current data layer is first determined in a mode of binary search based on the target keyword and the ranking position information of the preset quantity of disk files included in the current data layer in the current data layer. Then, whether the expired data exists in the corresponding primarily selected disk file in the current data layer or not is determined based on the bloom filter information of the primarily selected disk file. If YES, it indicates that the expired data actually exists in the primarily selected disk file, and the corresponding primarily selected disk file in the current data layer is determined as the target disk file.

If NO, the server transverses an upper data layer of the current data layer, and uses the upper data layer of the current data layer as the current data layer. The operations of first determining the primarily selected disk file corresponding to the expired data in the current data layer in a mode of binary search based on the target keyword and the ranking position information of the preset quantity of disk files included in the current data layer in the current data layer, and then, determining whether the expired data exists in the corresponding primarily selected disk file in the current data layer or not based on the bloom filter information of the primarily selected disk file are repeated. If YES, it indicates that the expired data actually exists in the primarily selected disk file, and the corresponding primarily selected disk file in the current data layer is determined as the target disk file.

If NO, an upper data layer of the current data layer is continuously traversed, the upper data layer of the current data layer is used as the current data layer, and the above operations are repeated until the first data layer is traversed. In a case that the target disk file in which the expired data is located is still not found when traversed to the first data layer (i.e., in a case that the current data layer is the first data layer), the expired data is most probably in the first data layer, and the server may directly determine the disk file in the first data layer as the target disk file.

A process of determining the target disk file in which the expired data is located will be illustrated hereafter by using an example:

It is supposed that the log-structured merge tree includes 5 data layers which are respectively an L0 data layer, an L1 data layer, an L2 data layer, an L3 data layer, and an L4 data layer. The server first uses the L4 data layer as the current data layer, and determines the primarily selected disk file corresponding to the expired data in the L4 data layer in a mode of binary search according to the target keyword and the ranking position information of the preset quantity of disk files included in the L4 data layer in the L4 data layer, that is, a range of the disk file in which the expired data may fall, in the L4 data layer is determined. The server determines whether the expired data really exists in the disk file or not according to the bloom filter information of the primarily selected disk file. If YES, the disk file in the L4 data layer is used as the target disk file, so that the Key of the expired data may be written into a cache structure corresponding to the L4 data layer in a subsequent operation. If NO, the server uses the L3 data layer as the current data layer.

The server determines the primarily selected disk file corresponding to the expired data in the L3 data layer in a mode of binary search according to the target keyword and the ranking position information of the preset quantity of disk files included in the L3 data layer in the L3 data layer, that is, a range of the disk file in which the expired data may fall, in the L3 data layer is determined. The server determines whether the expired data really exists in the disk file or not according to the bloom filter information of the primarily selected disk file. If YES, the disk file in the L3 data layer is used as the target disk file, so that the expired file may be written into a cache structure corresponding to the L3 data layer in a subsequent operation. If NO, the server uses the L2 data layer as the current data layer.

Similarly, if the target disk file in which the expired data is located is not found in the L1 data layer, the server transverses the L0 data layer, and the disk file in the L0 data layer is used as the target disk file, so that the Key of the expired data may be written into the cache structure corresponding to the L0 data layer in a subsequent operation.

The mode of sequentially performing the binary search and the bloom filter operation according to the sequence of each data layer in the LSM tree in the embodiments of this disclosure is not a mode of transversing each data layer, but is a mode of transversing the upper data layer when the target disk file in which the Key of the expired data is located is not found in the later data layer, and the transversal on the upper data layers is not needed when the target disk file is found in the later data layer, so that the transversal times may be reduced, and the consumption of the target disk file determination process on the system resource is reduced.

In an embodiment, a corresponding counting apparatus may be arranged in each data layer for each disk file. For example, each disk file in each data layer corresponds to a respective counting apparatus. In some examples, a counting apparatus corresponds to a counter or a counter value associated with a respective disk file and recorded in the corresponding cache structure. After the target keyword is written into the cache structure corresponding to the data layer in which the target disk file is located, the method may further include:
add 1 to the quantity of the counting apparatuses corresponding to the target disk file.

Correspondingly, in operation S207, the positioning, in response to the quantity of the keyword in the cache structure corresponding to at least one data layer satisfying a preset quantity condition and by means of the meta-information identified by the keyword in the cache structure respectively corresponding to the at least one data layer, the expired data in the disk files included in the at least one data layer. For example, based on the quantities of the counting apparatuses corresponding to the disk files included in at least one data layer of the log-structured merge tree satisfying the preset quantity condition and based on the meta-information identified by the keywords in the cache structure respectively corresponding to the at least one data layer, the expired data in the disk files included in the at least one data layer are positioned. In some examples, performing recovery processing on the positioned expired data may include:
perform recovery processing on the expired data in the disk files included in each data layer according to the quantity of the counting apparatuses corresponding to the disk files included in each data layer.

In this embodiment, a counting apparatus, for example, a counter, may be maintained for each disk file included in each data layer at each data layer of the LSM tree. The quantity in the counting apparatus (for example, a stored count value) represents the quantity of the expired data in the corresponding disk file. After one keyword is stored into the corresponding cache structure, 1 may be added to the quantity of the counting apparatus corresponding to the disk file in which the keyword is located. After writing the target keyword into the cache structure corresponding to the data layer in which the target disk file is located, the server may add 1 to the quantity of the counting apparatus corresponding to the target disk file, and the quantity of the counting apparatus corresponding to the target disk file is configured for representing the quantity of the expired data in the target disk file.

When the server writes the target keyword into the cache structure corresponding to the data layer in which the target disk file is located, and adds 1 to the quantity of the counting apparatus corresponding to the target disk file, an operation of writing another keyword into the cache structure corresponding to the data layer in which another disk file is located and adding 1 to the quantity of the counting apparatus corresponding to another disk file may also exist, that is, the disk files included in each data layer may have a corresponding quantity of the counting apparatus, the server may perform recovery processing on the expired data in the disk files included in each data layer according to the quantity of the counting apparatus corresponding to the disk files included in each data layer. The information of the expired data in each disk file may be accurately expressed by the quantity of the maintained counting apparatus, so the quantity of the maintained counting apparatuses may be used as the basis for triggering the data recovery, and the expired data may be timely and accurately recovered.

The operation of performing recovery processing on the expired data in the disk files included in each data layer according to the quantity of the counting apparatuses corresponding to the disk files included in each data layer may be implemented in various modes, that is, a recovery program may be diversely triggered, which is not specifically limited therein.

In an implementation, whether a recovery program is started on the expired data in a disk file or not may be actively determined according to whether the expired data in the disk file meets a preset quantity condition or not. In another implementation, the recovery program may be attached to a compaction program, and a compaction triggering mechanism is additionally added to achieve the goal of recovering the expired data.

Hereafter, a process of performing recovery processing on the expired data in the disk file is illustrated by taking “actively determining whether a recovery program is started on the expired data in a disk file or not according to whether the expired data in the disk file meets a preset quantity condition or not” as an example.

Correspondingly, the operation of performing recovery processing on the expired data in the disk files included in each data layer according to the quantity of the counting apparatuses corresponding to the disk files included in each data layer may include:
in a case that the quantity of the counting apparatus corresponding to a preset disk file satisfies a preset quantity condition and by means of the meta-information identified by the keyword in the cache structure corresponding to the data layer in which the preset disk file is located, position the expired data in the preset disk file, delete the positioned expired data, and rewrite the preset disk file with the expired data being deleted into a disk for storing the preset disk file; or,
in a case that both the quantity of the counting apparatus corresponding to the preset disk file and the quantity of the counting apparatus corresponding to an adjacent disk file satisfy a preset quantity condition and by means of the meta-information identified by the keyword in the cache structure corresponding to the data layer in which the preset disk file is located, position expired data in the preset disk file, delete the positioned expired data and expired data in the adjacent disk file, rewrite the preset disk file with the expired data being deleted into a disk for storing the preset disk file, and rewrite the adjacent disk file with the expired data being deleted into a disk for storing the adjacent disk file.

In an embodiment, the preset disk file may be any one disk file in the disk files included in each data layer, and the adjacent disk file may be a disk file positioned in the same data layer as the preset disk file and being adjacent to the preset disk file.

In an embodiment, the “the quantity of the counting apparatus corresponding to a preset disk file satisfies a preset quantity condition” may refer to that: a ratio of the quantity of the counting apparatus corresponding to the preset disk file (i.e., the quantity of the expired data in the preset disk file) to the total quantity of all data included in the preset disk file is greater than a preset ratio threshold, and the preset ratio threshold may be set according to practical service requirements, which is not specifically limited herein. Alternatively, the “the quantity of the counting apparatus corresponding to a preset disk file satisfies a preset quantity condition” may refer to that: the quantity of the counting apparatus corresponding to the preset disk file (i.e., the quantity of the expired data in the preset disk file) is greater than certain preset quantity threshold, and the preset quantity threshold may be set according to practical service requirements, which is not specifically limited herein.

The server may transverse the counting apparatuses maintained for each disk file in real time or regularly. In a case that the server discovers that the quantity of the counting apparatus corresponding to certain preset disk file satisfies the preset quantity condition, the recovery program on the preset disk file is actively triggered. In one mode, the preset disk file may be separately rewritten once to delete the expired data in the preset disk file. For example, the expired data in the preset disk file is deleted, and the preset disk file with the expired data being deleted is rewritten into the disk.

In another mode, some adjacent disk files may be rewritten in a combined mode to improve the recovery efficiency on the expired data. In some examples, the combined rewriting process may be as follows: the server may transverse the counting apparatuses maintained for each disk file in real time or regularly. In a case that the server discovers that the quantity of the counting apparatus corresponding to certain preset disk file satisfies the preset quantity condition, and simultaneously discovers that the quantity of the counting apparatus corresponding to the adjacent disk file satisfies the preset quantity condition, the preset disk file and the adjacent disk file are rewritten in a combined mode. For example, the expired data in the preset disk file and the expired data in the adjacent disk file are deleted at the same time, and the preset disk file with the expired data being deleted and the adjacent disk file with the expired data being deleted are rewritten into the disk at the same time.

In this embodiment, the quantity of the maintained counting apparatus may accurately express the information of the expired data in each disk file, so whether the quantity of the counting apparatus corresponding to the disk file satisfies the preset quantity condition or not is used as a basis of triggering the data recovery, rather than attaching the expired data recovery to a compaction program, the expired data may be actively recovered, so that the expired data recovery is in a controllable range, the expired data recovery efficiency and accuracy are improved, and the expired data recovery costs are reduced.

Hereafter, a process of performing recovery processing on the expired data in the disk file will be illustrated by taking “attaching the recovery program to a compaction program, and additionally adding a compaction triggering mechanism to achieve the goal of recovering the expired data” as an example.

Correspondingly, the operation of performing recovery processing on the expired data in the disk files included in each data layer according to the quantity of the counting apparatuses corresponding to the disk files included in each data layer may include:
in response to a merging instruction and according to the quantity of the counting apparatuses corresponding to the disk files included in each data layer, determine whether the quantity of expired data in the disk files in a first preset range is greater than a first preset quantity threshold or not, where the first preset range is a data range in any one data layer of the at least two data layers.

In a case of determining that the quantity of expired data in the disk files in the first preset range is greater than the first preset quantity threshold and the total quantity of data in the disk files in the first preset range is smaller than a second preset quantity threshold, ranking processing is performed on the data in the first preset range and data in the second preset range to perform recovery processing on the expired data in the disk files in the first preset range. The data layer in which the second preset range is located is a next data layer of the data layer in which the first preset layer is located, and the data in the first preset range and the data in the second preset range have an intersection.

The merging instruction may be triggered by a terminal object, or may be regularly and automatically triggered by the server.

When one compaction is triggered, the server may select data in certain first preset range in the adjacent layer for organization. The data in the first preset range satisfies a condition that the total related data quantity does not exceed the second preset quantity threshold, and the related expired data ratio is greater than the first preset quantity threshold. In an embodiment, the first preset range may be a total data range in any one data layer, and may also be a part of the data range in any one data layer. The first preset quantity threshold and the second preset quantity threshold may be set according to the practical service requirements, which is not specifically limited therein. For example, that the expired data ratio is greater than the first preset quantity threshold may refer to that the ratio of the expired data in the first preset range is the highest, and the like.

The server may acquire the quantity of the counting apparatuses corresponding to the disk files included in each data layer in response to the merging instruction. The quantity of the maintained counting apparatus may accurately express the information of the expired data in each disk file in each data layer, so whether the quantity of the expired data in the disk files in certain first preset range in any one data layer is greater than the first preset quantity threshold or not may be determined according to the quantity of the counting apparatuses corresponding to the disk files included in each data layer.

In a case that the server determines that the quantity of the expired data in the disk files in the first preset range is greater than the first preset quantity threshold, the server may further determine whether the total quantity of data in the disk file in the first preset range is smaller than the second preset quantity threshold or not. If YES, data in certain range in the adjacent data layer is organized. Specifically, the server performs ranking processing on the data in the first preset range and the data in the second preset range to perform recovery processing on the expired data in the disk files in the first preset range.

The data in certain range in the adjacent data layer is organized, the data layer in which the second preset range is located may be a next data layer of the data layer in which the first preset layer is located, and the data in the first preset range and the data in the second preset range have an intersection.

Therefore, the data in certain range in the adjacent layer may be organized by using the additionally added compaction triggering mechanism. The quantity of the expired data in the disk files in the first preset range is greater than the first preset quantity threshold, and the total quantity of data in the disk files in the first preset range is smaller than the second preset quantity threshold, so the expired data may be recovered as much as possible, so that the recovery efficiency on the expired data is improved.

In other implementations, a counting apparatus may not be maintained for each disk file, the quantity of the expired data in each disk file is directly read from the cache structure corresponding to each data layer, and the expired data in each disk file is subjected to recovery processing according to the read quantity of the expired data in each disk file. In an implementation, the server may directly read the quantity of the expired data in each disk file from the cache structure corresponding to each data layer. When the ratio of the expired data in certain disk file to the total quantity of data included in the disk file is determined to reach certain ratio, the disk file is subjected to separate rewriting processing to delete the expired data; or several adjacent disk files are rewritten to delete the expired data. In another implementation, a compaction triggering mechanism may be additionally added. When the compaction is triggered, the data in certain range in the adjacent layer is selected for organization to recover the expired data as much as possible, and the recovery efficiency on the expired data is improved.

Hereafter, the data processing method in the embodiments of the present disclosure will be integrally illustrated:

FIG. 6 is a schematic flow chart of a data processing method according to an embodiment. As shown in FIG. 6,
it is supposed that the LSM tree includes 8 data layers, which are respectively L0, L1, L2, L3, L4, L5, L6, and L7.

It is supposed that target data corresponding to Key1 and target data corresponding to Key2 stored in the LSM tree are subjected to a write operation at the same time, then the expired data is the target data corresponding to Key1 and the target data corresponding to Key2, and the target keywords are Key1 and Key2.

The server acquires file identifier information (SST ID) of a preset quantity of disk files included in each data layer based on Key1 and Key2, and the server acquires bloom filter information corresponding to the disk files according to the SST ID, so as to search the target data corresponding to Key1 and the target data corresponding to Key2 are located in which disk file of which data layer according to the bloom filter information. As shown in FIG. 6, it is supposed that the target data corresponding to Key1 and the target data corresponding to Key2 are located in the disk file 1 of the L6 layer,
and in an expired data recovery process, a compaction triggering mechanism may be additionally added to organize the data in certain range in the adjacent layer. The process may be specifically as follows: it is supposed that the quantity of the expired data in the disk file in the first preset range (the range corresponding to the disk file 1) in the L6 layer is greater than the first preset quantity threshold, the total quantity of data in the disk file in the first preset range is smaller than the second preset quantity threshold, and in addition, the data in the first preset range in the L6 layer and the data in the second preset range in the L7 layer have an intersection, when one additional compaction mechanism is triggered, the server may perform ranking processing on the data in the first preset range in the L6 layer and the data in the second preset range in the L7 layer, so as to perform recovery processing on the expired data in the disk file (i.e., the disk file 1) in the first preset range in the L6 layer to acquire the target disk file.

The embodiments of this disclosure may be applied to a distributed database management system (for example, a distributed database TDSQL system). The TDSQL distributed database system uses an architecture of separating storage and computing, and supports distributed transaction and distributed storage. The recovery mechanism for the expired data in the LSM tree in the embodiments of this disclosure may be configured for the expired data recovery of a single storage node in the distributed storage. By using this recovery mechanism, the expired data may be actively recognized, greater convenience and higher flexibility may be realized during expired data clearing, and the TDSQL database system may be well improved in aspects of disk space amplification as well as read and write amplification.

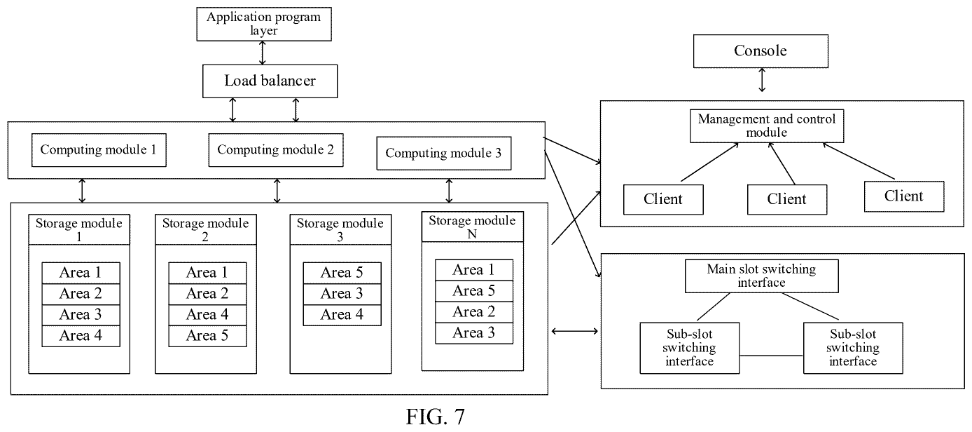

FIG. 7 is an overall framework diagram of a TDSQL distributed database system according to an embodiment. As shown in FIG. 7, the TDSQL distributed database system may include:
A computing module (SQLEngine): a multi-master mode is adopted, and each SQLEngine may be read and written; a statelessness design is adopted, and a quantity of computing nodes may be flexibly added or removed at any time according to service flow requirements.
A storage module (TDStore): according to service data storage quantity requirements, distributed storage nodes (TDStore nodes) may be added or removed, the autoscaling of the volume may be realized through automatic data migration without being perceived by a service layer.
A management and control module (TDMetaCluster): it is responsible for scheduling the splitting, merging, migration, and master node switching of data partitions; performing capacity expansion and contraction scheduling on a storage layer; realizing load balancing scheduling on the storage layers; and providing an abnormal event warning in each dimension.

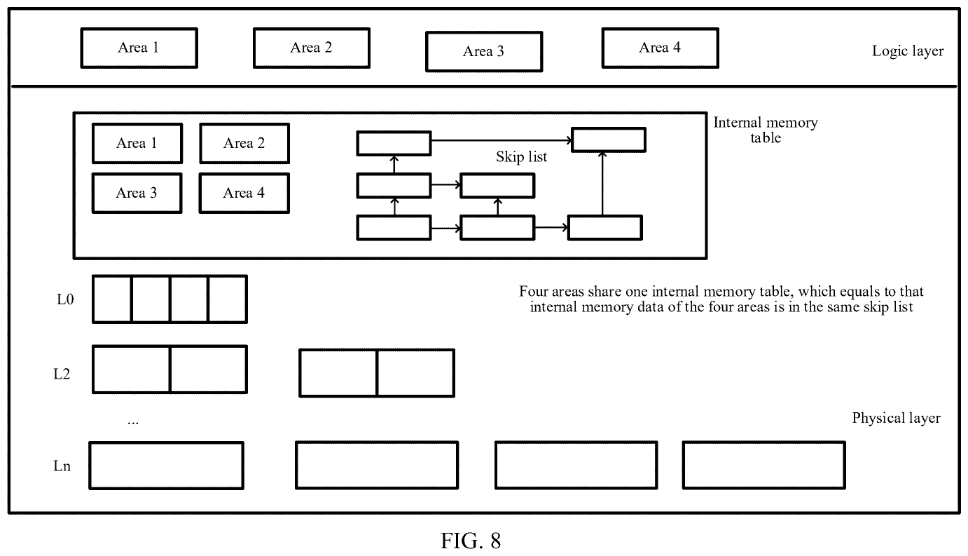

FIG. 8 is a storage framework diagram of a single storage node according to an embodiment. As shown in FIG. 8, the TDSQL is used as a distributed database management system, each storage node stores data of a plurality of data partitions, and the data of different data partitions may be scheduled in each storage node. Specifically for a single storage node, the data of all data partitions is stored in one LSM tree. The LSM tree continuously sorts the data in different layers through the compaction program, so as to reach the read and write performance balance on the stored data.

FIG. 9 is a block diagram of a data processing apparatus according to an embodiment. As shown in FIG. 9, the data processing apparatus includes:
an expired data acquiring module 901, configured to determine, in response to a write operation for target data in a log-structured merge tree, expired data generated by the write operation; the log-structured merge tree including at least two data layers, each data layer including a preset quantity of disk files, each data layer corresponding to a cache structure, and each cache structure being configured to store meta-information of the expired data in the corresponding data layer;
a target disk file searching module 903, configured to determine a keyword of the target data as a target keyword of the expired data, and search, based on the target keyword, the preset quantity of disk files included in each data layer for a target disk file in which the expired data is located;
a keyword writing module 905, configured to write the target keyword into the cache structure corresponding to the data layer in which the target disk file is located; the target keyword being configured for identifying the meta-information of the expired data in the target disk file; and
a recovery module 907, configured to position, in response to the quantity of the keyword in the cache structure corresponding to at least one data layer satisfying a preset quantity condition and by means of the meta-information identified by the keyword in the cache structure respectively corresponding to the at least one data layer, the expired data in the disk files included in the at least one data layer, and perform recovery processing on the positioned expired data.

In an embodiment, the target disk file searching module includes:
a primarily selected disk file determination unit, configured to determine, based on the target keyword and ranking position information of the preset quantity of disk files included in each data layer in each data layer, a primarily selected disk file corresponding to the expired data; and
a target disk file determination unit, configured to determine the primarily selected disk file as the target disk file in a case of determining that the expired data exists in the primarily selected disk file based on bloom filter information of the primarily selected disk file.

In an embodiment, the preset quantity of disk files in each candidate data layer of the at least two data layers are sequentially arranged, and the candidate data layer is a data layer other than the first data layer of the at least two data layers. The primarily selected disk file determination unit includes:
a comparison subunit, configured to compare the target keyword with a first candidate keyword of a disk file in a middle position in each candidate data layer;
a middle disk file determination subunit, configured to determine the primarily selected disk file as the disk file in the middle position in each candidate data layer in a case that the target keyword equals to the first candidate keyword;
a first searching subunit, configured to search disk files in front of the disk file in the middle position for a disk file with the keyword being identical to the target keyword to acquire the primarily selected disk file in a case that the target keyword is smaller than the first candidate keyword; and
a second searching subunit, configured to search disk files behind the disk file in the middle position for a disk file with the keyword being identical to the target keyword to acquire the primarily selected disk file in a case that the target keyword is greater than the first candidate keyword.

In an embodiment, the bloom filter information of the primarily selected disk file is of a data structure formed by a bit array having a length of a preset bit and a preset quantity of hash functions. The target disk file determination unit includes:
a hashing processing subunit, configured to perform hashing processing on the target keyword through the preset quantity of hash functions to acquire a preset quantity of hash values;
a mapping subunit, configured to map the target keyword to the bit array through the preset quantity of hash values to acquire a preset quantity of mapping results; and
a target disk file generation subunit, configured to determine that the expired data exists in the primarily selected disk file in a case that the preset quantity of mapping results are all 1, and determine the primarily selected disk file as the target disk file.

In an embodiment, the apparatus further includes:
a non-target disk file determination module, configured to determine that the expired data does not exist in the primarily selected disk file in a case that any one mapping result in the preset quantity of mapping results is 0, and determine the primarily selected disk file not to be the target disk file.

In an embodiment, the target disk file searching module includes:
a current data layer determination unit, configured to determine the last layer of the log-structured merge tree as a current data layer; the preset quantity of disk files in the current data layer being sequentially arranged;
a current primarily selected disk file determination unit, configured to determine, based on the target keyword and the ranking position information of the preset quantity of disk files included in the current data layer in the current data layer, a primarily selected disk file corresponding to the expired data in the current data layer;
a redetermination unit, configured to redetermine an upper data layer of the current data layer as the current data layer in a case of determining the corresponding primarily selected disk file based on bloom filter information of the primarily selected disk file;
a repeating unit, configured to repeat the operations of the based on the target keyword and the ranking position information of the preset quantity of disk files included in the current data layer in the current data layer to the redetermining an upper data layer of the current data layer as the current data layer, until the current data layer is the first data layer of the log-structured merge tree; and

a target disk file determination subunit, configured to determine the disk file in the first data layer as the target disk file.

In an embodiment, the apparatus further includes:
a file existence determination module, configured to determine the corresponding primarily selected disk file as the target disk file in a case of determining that the expired data exists in the corresponding primarily selected disk file based on bloom filter information of the primarily selected disk file.

In an embodiment, the apparatus further includes:
a counting adjustment module, configured to add 1 to the quantity of the counting apparatuses corresponding to the target disk file.

The recovery module includes:
a recovery processing unit, configured to perform recovery processing on the expired data in the disk files included in each data layer according to the quantity of the counting apparatuses corresponding to the disk files included in each data layer.

In an embodiment, the recovery processing unit includes:
a first deletion subunit, configured to in a case that the quantity of the counting apparatuses corresponding to a preset disk file satisfies a preset quantity condition and by means of the meta-information identified by the keyword in the cache structure corresponding to the data layer in which the preset disk file is located, position the expired data in the preset disk file, delete the positioned expired data, and rewrite the preset disk file with the expired data being deleted into a disk for storing the preset disk file; or,
a second deletion subunit, configured to in a case that both the quantity of the counting apparatuses corresponding to the preset disk file and the quantity of the counting apparatuses corresponding to an adjacent disk file satisfy a preset quantity condition and by means of the meta-information identified by the keyword in the cache structure corresponding to the data layer in which the preset disk file is located, position expired data in the preset disk file, delete the positioned expired data and expired data in the adjacent disk file, rewrite the preset disk file with the expired data being deleted into a disk for storing the preset disk file, and rewrite the adjacent disk file with the expired data being deleted into a disk for storing the adjacent disk file.

The preset disk file is any one disk file in the disk files included in each data layer, and the adjacent disk file is a disk file adjacent to the preset disk file.

In an embodiment, the recovery processing unit includes:
a response subunit, configured to in response to a merging instruction and according to the quantity of the counting apparatuses corresponding to the disk files included in each data layer, determine whether the quantity of expired data in the disk files in a first preset range is greater than a first preset quantity threshold or not; the first preset range being a data range in any one data layer of the at least two data layers; and
a ranking processing subunit, configured to perform ranking processing on data in the first preset range and data in a second preset range to perform recovery processing on the expired data in the disk files in the first preset range in a case of determining that the quantity of expired data in the disk files in the first preset range is greater than the first preset quantity threshold and the total quantity of data in the disk files in the first preset range is smaller than the second preset quantity threshold.

The data layer in which the second preset range is located is a next data layer of the data layer in which the first preset range is located, and the data in the first preset range and the data in the second preset range have an intersection.

The apparatus embodiments and the method embodiments provided by the embodiments of this disclosure are based on the same inventive concept.

Embodiments of this disclosure further provide an electronic device for data processing. The electronic device includes processing circuitry (such as a processor) and a memory. The memory has at least one instruction or at least one program stored therein, and the at least one instruction or the at least one program is loaded and executed by the processor to implement the data processing method provided by any one embodiment provided above.

Embodiments of this disclosure further provide a non-transitory computer-readable storage medium. The non-transitory computer-readable storage medium has at least one instruction or at least one program stored therein, and the at least one instruction or the at least one program is loaded and executed by processing circuitry (such as a processor) to implement the data processing method provided by the above method embodiment.

In some embodiments, in the embodiments of this specification, the storage medium may be positioned in at least one network server of a plurality of network servers in a computer network. In some embodiments, in this embodiment, the storage medium may include but is not limited to: media capable of storing program codes, such as a USB flash disk, a read-only memory (ROM), a random access memory (RAM), a mobile hard disk, a magnetic disk, or a compact disc.

The memory provided by the embodiments of this disclosure may be configured to store a software program and a module. The processor executes various application programs and performs data processing through running the software program and the module stored on the memory. The memory may mainly include a program storage area and a data storage area. The program storage area may store application programs required for operating the system, functions, and the like. The data storage area may store data created based on the use of the device, and the like. In addition, the memory may include a high-speed random access memory, and may further include a non-volatile memory, such as at least one disk storage device, a flash memory, or another volatile solid-state storage device. Correspondingly, the memory may further include a memory controller, so as to provide access of the processor to the memory.

Embodiments of this disclosure also provide a computer program product or a computer program. The computer program product or the computer program includes a computer instruction. The computer instruction is stored in a non-transitory computer-readable storage medium. A processor of an electronic device reads the computer instruction from the non-transitory computer-readable storage medium, and the processor executes the computer instruction, so that the electronic device executes the data processing method provided by the above method embodiments.

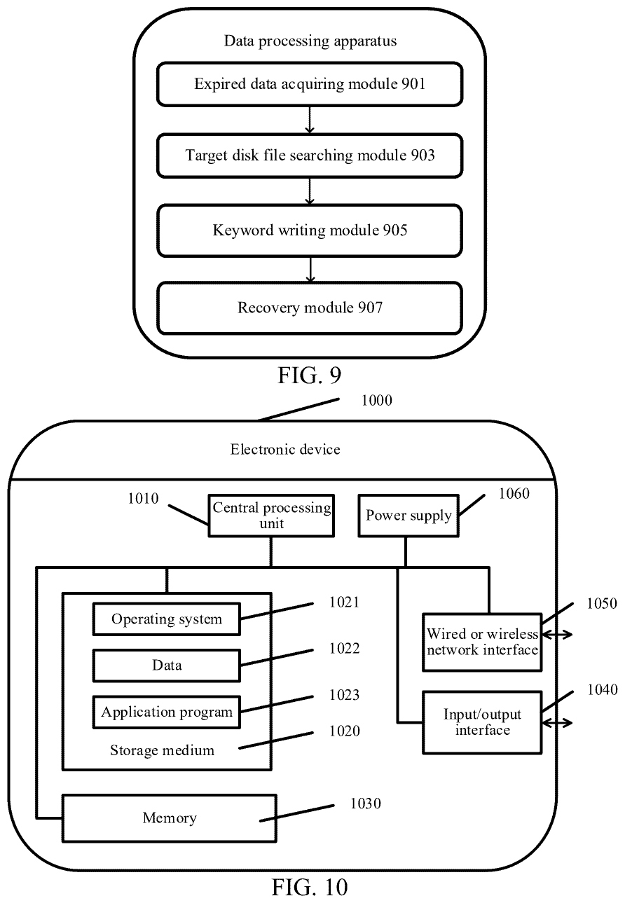

The embodiments of the data processing method provided in the embodiments of this disclosure may be executed on an electronic device. The electronic device is, for example, a terminal, a computer terminal, an electronic device, or a similar computing apparatus. Electric device: FIG. 10 is a block diagram of a hardware structure of an electronic device provided according to an embodiment. As shown in FIG. 10, the electronic device 1000 may have great differences due to different configurations or performance, and may include processing circuitry, such as one or more central processing units (CPU) 1010 (the central processing unit 1010 may include but is not limited to a processing apparatus such as a microprocessor (micro control unit (MCU)) or a programmable logic device (field-programmable gate array (FPGA))). In some examples, the electronic device 1000 may include a memory 1030 configured to store data, and one or more storage medium 1020 (for example, one or more massive storage device) configured to store an application program 1023 or data 1022. In some examples, the one or more storage medium 1020 includes a non-transitory computer-readable storage medium. The memory 1030 and the storage medium 1020 may be configured for temporary storage or persistent storage. A program stored in the storage medium 1020 may include one or more modules, and each module may include a series of instruction operations in the electronic device. Further, the central processing unit 1010 may be configured to communicate with the storage medium 1020, and perform, on the electronic device 1000, a series of instruction operations in the storage medium 1020. The electronic device 1000 may further include one or more power supplies 1060, one or more wired or wireless network interfaces 1050, one or more input/output interfaces 1040, and/or one or more operating systems 1021, for example, Windows Server™, Mac OS X™, Unix™, Linux™, or FreeBSD™.

The input/output interface 1040 may be configured to receive or transmit data through a network. A specific example of the network may include a wireless network provided by a communication supplier of the electronic device 1000. In an example, the input/output interface 1040 includes a network interface controller (NIC) which is connected with other network devices through a base station, so as to communicate with Internet. In an example, the input/output interface 1040 may be a radio frequency (RF) module, which is configured to communicate with Internet in a wireless mode. A person of ordinary skill in the art may understand that the structure shown in FIG. 10 is only a schematic structure, and does not limit the structure of the electronic device. For example, the electronic device 1000 may further include more or fewer components than those shown in FIG. 10, or may have a configuration different from that shown in FIG. 10.

The order of the foregoing embodiments of this disclosure is merely for description purpose, and is not intended to indicate priorities of the embodiments. Specific embodiments of this disclosure are described above. Other embodiments are within the scope of the attached claims. In some cases, actions or operations recorded in the claims may be performed in a sequence different from that in the embodiments and may still achieve the expected result. In addition, the processes described in the accompanying drawings do not necessarily require the shown particular order or sequential order to achieve the expected results. In some implementations, multitasking processing and parallel processing may also be possible or advantageous.

Embodiments of this specification are all described in a progressive mode. For the same or similar parts in the embodiments, references may be taken. Detailed descriptions of each embodiment focus on differences from other embodiments. For the embodiments of the apparatus and the electronic device, they are basically similar to the embodiments of the method, so the descriptions are simple, and some descriptions of the embodiments of the method may be taken as the reference for the relevant parts.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing embodiments only describe several implementations of this disclosure as non-limiting examples. Any modification, equivalent replacement, improvement, and the like made within the spirit and scope of this disclosure shall fall within the scope of this disclosure.

What is claimed is:

1. A data processing method, comprising:
determining, based on a write operation for target data in a log-structured merge tree, target expired data as a result of the write operation, the log-structured merge tree including at least two data layers, and each data layer including a preset quantity of disk files;
determining a keyword of the target data as a target keyword of the target expired data;
searching, based on the target keyword, the disk files included in each data layer for one or more target disk files in which the target expired data is located;
writing, by processing circuitry, target meta-information of the target expired data in the one or more target disk files and the target keyword identifying the target meta-information into one or more respective cache structures corresponding to the at least two data layers in which the one or more target disk files are located;
positioning, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer; and
performing, by the processing circuitry, recovery processing on the positioned expired data.

2. The data processing method according to claim 1, wherein the searching the disk files comprises:
determining, based on the target keyword and ranking position information of the disk files included in each data layer, one or more primarily selected disk files corresponding to the target expired data; and
determining the one or more primarily selected disk files as the one or more target disk files based on a determination result that the target expired data exists in the one or more primarily selected disk files according to bloom filter information of the one or more primarily selected disk files.

3. The data processing method according to claim 2, wherein
the disk files in each candidate data layer of the at least two data layers are sequentially arranged, the candidate data layer being a data layer other than a top data layer of the at least two data layers, and
the determining the one or more primarily selected disk files includes:
comparing the target keyword with a first candidate keyword of a first disk file in a middle position in each candidate data layer; and
determining the first disk file in the middle position in each candidate data layer as one of the one or more primarily selected disk files based on the target keyword being equal to the first candidate keyword.

4. The data processing method according to claim 3, wherein the determining the one or more primarily selected disk files comprises:
based on the target keyword being smaller than the first candidate keyword, searching one or more other disk files in front of the first disk file in the middle position for a second disk file with a second candidate keyword being identical to the target keyword, the second disk file being determined as the one of the one or more primarily selected disk files.

5. The data processing method according to claim 3, wherein the determining the one or more primarily selected disk files comprises:
based on the target keyword being greater than the first candidate keyword, searching one or more disk files behind the disk file in the middle position for a third disk file with a third candidate keyword being identical to the target keyword, the third disk file being determined as one of the one or more primarily selected disk files.

6. The data processing method according to claim 2, wherein
the bloom filter information of a corresponding one of the one or more primarily selected disk files corresponds to a data structure formed by a bit array having a length of a preset bit and a preset number of hash functions, and
the determining the one or more primarily selected disk files as the one or more target disk files includes:
performing hashing processing on the target keyword through the preset number of hash functions to acquire a preset number of hash values;
obtaining a preset number of mapping results based on the target keyword being mapped to the bit array through the preset number of hash values; and
determining that the target expired data exists in the corresponding one of the one or more primarily selected disk files based on the preset number of mapping results are all 1, such that the corresponding one of the one or more primarily selected disk files is determined as one of the one or more target disk files.

7. The data processing method according to claim 6, further comprising:
determining that the target expired data does not exist in the corresponding one of the one or more primarily selected disk files based on any one mapping result in the preset number of mapping results is 0, such that the corresponding one of the one or more primarily selected disk files is not determined as one of the one or more target disk files.

8. The data processing method according to claim 2, wherein the searching the disk files included in each data layer for the one or more target disk files comprises:
determining, for each current data layer from a bottom data layer to a second-to-top data layer of the log-structured merge tree, and based on the target keyword and ranking position information of the disk files included in the current data layer, a current one of the one or more primarily selected disk files corresponding to the target expired data in the current data layer; and
determining the disk file in a top data layer of the log-structured merge tree as one of the one or more target disk files.

9. The data processing method according to claim 8, further comprising:
determining, for each current data layer from the bottom data layer to the second-to-top data layer of the log-structured merge tree, the current one of the one or more primarily selected disk files as one of the one or more target disk files based on a determination result that the target expired data exists in the corresponding primarily selected disk file based on the bloom filter information of the corresponding primarily selected disk file.

10. The data processing method according to claim 1, wherein
each disk file in each data layer corresponds to a respective counting apparatus,
the method includes:
adding 1 to the quantity of the counting apparatus for a corresponding target disk file after the target keyword is written into the cache structure corresponding to the data layer in which the target disk file is located, and
the positioning the expired data in the disk files includes:
positioning, based on the quantities of the counting apparatuses corresponding to the disk files included in at least one data layer of the log-structured merge tree satisfying the preset quantity condition and based on the meta-information identified by the keywords in the cache structure respectively corresponding to the at least one data layer, the expired data in the disk files included in the at least one data layer.

11. The data processing method according to claim 10, wherein
the positioning the expired data in the disk files includes:
based on the quantity of the counting apparatus corresponding to a preset disk file satisfies the preset quantity condition and based on the meta-information identified by the keywords in the cache structure corresponding to the data layer in which the preset disk file is located, positioning the expired data in the preset disk file, and
the performing the recovery processing includes:
deleting the positioned expired data from the preset disk file; and
rewriting the preset disk file with the expired data being deleted into a storage device configured to store the preset disk file.

12. The data processing method according to claim 10, wherein
the positioning the expired data in the disk files includes:
based on both the quantity of the counting apparatus corresponding to a preset disk file and the quantity of the counting apparatus corresponding to an adjacent disk file adjacent to the preset disk file satisfying the preset quantity condition and based on the meta-information identified by the keywords in the cache structure corresponding to the data layer in which the preset disk file and the adjacent disk file located, positioning the expired data in the preset disk file, and
the performing the recovery processing includes:
deleting the positioned expired data from the preset disk file and the expired data from the adjacent disk file;
rewriting the preset disk file with the expired data being deleted into a storage device configured to store the preset disk file; and
rewriting the adjacent disk file with the expired data being deleted into the storage device or another storage device configured to store the adjacent disk file.

13. The data processing method according to claim 10, wherein
the positioning the expired data in the disk files includes:
based on a merging instruction, according to the quantity of the counting apparatuses corresponding to the disk files included in each data layer and based on the meta-information identified by the keywords in the cache structure corresponding to the data layer in which the disk files in a first preset range are located,
determining the quantity of expired data in the disk files in the first preset range, and
determining whether the quantity of expired data in the disk files in the first preset range is greater than a first preset quantity threshold or not,
the first preset range being a data range in any one data layer of the at least two data layers,
the performing the recovery processing includes:
performing ranking processing on data in the first preset range and data in a second preset range; and
performing the recovery processing on the expired data in the disk files in the first preset range based on the quantity of expired data in the disk files in the first preset range being greater than the first preset quantity threshold and a total quantity of data in the disk files in the first preset range being smaller than a second preset quantity threshold,
the data layer in which the second preset range is located is next to the data layer in which the first preset range is located, and
the data in the first preset range and the data in the second preset range have an intersection.

14. A data processing apparatus, comprising:
processing circuitry configured to:
determine, based on a write operation for target data in a log-structured merge tree, target expired data as a result of the write operation, the log-structured merge tree including at least two data layers, and each data layer including a preset quantity of disk files;
determine a keyword of the target data as a target keyword of the target expired data;
search, based on the target keyword, the disk files included in each data layer for one or more target disk files in which the target expired data is located;
write target meta-information of the target expired data in the one or more target disk files and the target keyword identifying the target meta-information into one or more respective cache structures corresponding to the at least two data layers in which the one or more target disk files are located;
position, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer; and
perform recovery processing on the positioned expired data.

15. The data processing apparatus according to claim 14, wherein the processing circuitry is configured to:
determine, based on the target keyword and ranking position information of the disk files included in each data layer, one or more primarily selected disk files corresponding to the target expired data; and
determine the one or more primarily selected disk files as the one or more target disk files based on a determination result that the target expired data exists in the one or more primarily selected disk files according to bloom filter information of the one or more primarily selected disk files.

16. The data processing apparatus according to claim 15, wherein
the disk files in each candidate data layer of the at least two data layers are sequentially arranged, the candidate data layer being a data layer other than a top data layer of the at least two data layers, and
the processing circuitry is configured to:
compare the target keyword with a first candidate keyword of a first disk file in a middle position in each candidate data layer; and
determine the first disk file in the middle position in each candidate data layer as one of the one or more primarily selected disk files based on the target keyword being equal to the first candidate keyword.

17. The data processing apparatus according to claim 16, wherein the processing circuitry is configured to:
based on the target keyword being smaller than the first candidate keyword, search one or more other disk files in front of the first disk file in the middle position for a second disk file with a second candidate keyword being identical to the target keyword, the second disk file being determined as the one of the one or more primarily selected disk files.

18. The data processing apparatus according to claim 16, wherein the processing circuitry is configured to:
based on the target keyword being greater than the first candidate keyword, search one or more disk files behind the disk file in the middle position for a third disk file with a third candidate keyword being identical to the target keyword, the third disk file being determined as one of the one or more primarily selected disk files.

19. The data processing apparatus according to claim 15, wherein the processing circuitry is configured to:
determine, for each current data layer from a bottom data layer to a second-to-top data layer of the log-structured merge tree, and based on the target keyword and ranking position information of the disk files included in the current data layer, a current one of the one or more primarily selected disk files corresponding to the target expired data in the current data layer; and
determine the disk file in a top data layer of the log-structured merge tree as one of the one or more target disk files.

20. A non-transitory computer-readable storage medium storing instructions, which when executed by a processor, cause the processor to perform:
determining, based on a write operation for target data in a log-structured merge tree, target expired data as a result of the write operation, the log-structured merge tree including at least two data layers, and each data layer including a preset quantity of disk files;
determining a keyword of the target data as a target keyword of the target expired data;
searching, based on the target keyword, the disk files included in each data layer for one or more target disk files in which the target expired data is located;
writing target meta-information of the target expired data in the one or more target disk files and the target keyword identifying the target meta-information into one or more respective cache structures corresponding to the at least two data layers in which the one or more target disk files are located;
positioning, based on a quantity of keywords in the cache structure corresponding to at least one data layer satisfying a preset quantity condition and based on meta-information identified by the keywords in the cache structure corresponding to the at least one data layer, expired data in the disk files included in the at least one data layer; and
performing recovery processing on the positioned expired data.
